(19) United States
(12) Patent Application Publication
(10) Pub. No.: US 2020/0349112 A1
(43) Pub. Date: Nov. 5, 2020

(54) METHOD FOR CLASSIFYING LOG FILES ASSOCIATED WITH A SYSTEM

(71) Applicant: Hewlett Packard Enterprise Development LP, Houston, TX (US)

(72) Inventors: Anubhav Apurva, Bangalore Karnataka (IN); Jayasankar Nallasamy, Bangalore Karnataka (IN)

(21) Appl. No.: 16/856,706

(22) Filed: Apr. 23, 2020

(30) Foreign Application Priority Data
Apr. 30, 2019 (IN) 201941017235

(51) Int. Cl. G06F 16/16; G06N 20/00

(52) U.S. Cl. CPC G06F 16/16; G06N 20/00

(57) ABSTRACT

Examples include generating log line signatures for log lines of a plurality of log files, converting log line signatures to dimensional vectors, generating log file vectors and identifying one or more subsystems associated with each log file, based on a log file vector associated with the corresponding log file and a classification model.

### BACKGROUND

Log files are standard means for recording information regarding the operations and events of a computer system. Most computer systems essentially have several hundreds of log files from multiple components and subsystems such as firmware; drivers, enclosures, storage management software, etc.

### BRIEF DESCRIPTION OF THE DRAWINGS

The following detailed description references the drawings, wherein:

FIG. 1 is a block diagram of an example system with a one or more sub-systems and a log classification controller;

FIG. 2 is a flowchart of an example method for classifying log files associated with the system;

FIG. 3 is a flowchart of an example method for training a classification model for classifying log files associated with the system;

FIG. 4 is a block diagram of an example controller with machine-readable medium for classifying log files associated with the system;

FIG. 5 is an example log file with a plurality of example log lines; and

FIG. 6 is a vector space representation of example dimensional vectors.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two as or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

Examples described herein relate to classification of log data in accordance to various subsystems of a computer system. Logs files are generated by various computer systems for recording information regarding the operation and events in the computer systems. Upon the occurrence of a fault in the system, these log files are analyzed to identify the root cause of the fault. However, due to the volume of log files generated, identification of relevant log files is challenging, and often involves the intervention of highly skilled subject matter experts. Often, these logs are reviewed by the triage engineers which assign the log files to a particular developer group, after considerable review. Triage engineers have to analyze and correlate several number of log files to conclude upon right faulty software sub-module. This involves considerable expertise and knowledge about the computer system. Moreover, log data regarding system operations is often interspersed across multiple log files, displaced in several lines and may not be in specific sequence, thus searching for specific strings or return values and mapping directly to a software module can result in false negatives, as the system would have recovered to normal as designed. Examples described herein may address these limitations.

Some examples described herein may relate to a method for classifying logs in accordance with the subsystems of a computer system. This is further explained below.

In a first aspect, examples relate to a method for classifying log files. The method comprises receiving a plurality of log files from one or more subsystems of a system, generating a respective log line signature for each log line from the plurality of log lines of a corresponding log file from the plurality of log files, converting each log line signature associated with each log line from the plurality of log lines of a corresponding log file to a dimensional vector, generating a log file vector for a corresponding log file, from a plurality of a dimensional vectors associated with one or more log lines of the corresponding log file, and identifying one or more subsystems associated with each log file, based on a log file vector associated with the corresponding log file and a classification model.

Each log file includes a plurality of log lines associated with one or more events in the system. Each line from the plurality of lines comprising at least one of a timestamp and a process identifier. In an example, each log file from the plurality of log files is generated by extracting one or more log lines of each process log file from a plurality of process log files based on one or more of one or more corresponding systems tokens, timestamp and process identifier of each log line in the process log files. In an example, log line signature for each log line from the plurality of log lines of a corresponding log file is generated by hashing each log line using a predetermined hash function.

An angle between a first dimensional vector from the plurality of dimensional vectors and a second dimensional vector in the vector space, from the plurality of dimensional vectors is indicative of a relationship between a first log line associated with the first dimensional vector and a second log line associated with the second dimensional vector. In an example, the relationship between a first log line associated with the first dimensional vector and a second log line associated with the second dimensional vector, indicative of a contextual and textual similarity between the first log line and the second log line.

In an example, the method further comprises removing of a plurality of predefined words associated with the system from each log line from each log file from the plurality of log files. In an example, a log file vector for a corresponding log file is generated from a plurality of a dimensional vectors by calculating a mean vector from the plurality of dimensional vectors. In an example, the system is an enterprise storage system. In an example, one or more of the subsystems of the storage system are deployed in a remote site.

In a second aspect, examples relate to a method for training a classification model for classifying log files in accordance with the subsystems of the system. The method comprises receiving a plurality of training log files of a system, each training log file is associated with historic operations of a subsystem from one or more subsystems of the system; generating a respective log line signature for each log line from the plurality of log lines of a corresponding training log file from the plurality of training log files; converting each log line signature from a plurality of log line signatures associated with each log line from the plurality of log lines of a corresponding training log file to a dimensional vector; generating a training log file vector for a corresponding training log file, from a plurality of a dimensional vectors associated with one or more log lines of the corresponding training log file, and training a classification model based on the training log file vector associated with the corresponding log file and corresponding subsystem associated with the corresponding training log file.

In a third aspect, examples relate to a non-transitory machine-readable storage medium comprising instructions executable by at least one processor of a log classification controller to receive a plurality of log files from one or more subsystems of a system, generate a respective log line signature for each log line from the plurality of log lines of a corresponding log file from the plurality of log files, convert each log line signature associated with each log line from the plurality of log lines of a corresponding log file to a dimensional vector, generate a log file vector for a corresponding log file, from a plurality of a dimensional vectors associated with one or more log lines of the corresponding log file, and identify one or more subsystems associated with each log file, based on a log file vector associated with the corresponding log file and the classification model.

In a fourth aspect, examples relate to a storage system. The storage system comprises a plurality of subsystems, each subsystem associated with one or more operations of the storage system; one or more log repositories and a log classification controller. The one or more log repositories comprises a plurality of logs and are connected to the plurality of subsystems. The log classification controller comprising at least one processor and at least one non-transitory machine-readable storage medium. The non-transition machine-readable storage medium comprises instructions executable by the at least one processor to: receive the plurality of log files, generate a respective log line signature for each log line from the plurality of log lines of a corresponding log file from the plurality of log files, convert each log line signature associated with each log line from the plurality of log lines of a corresponding log file to a dimensional vector; generate a log file vector for a corresponding log file, from a plurality of a dimensional vectors associated with one or more log lines of the corresponding lag file, and identify one or more subsystems associated with each log file, based on a log file vector associated with the corresponding log file and the classification model.

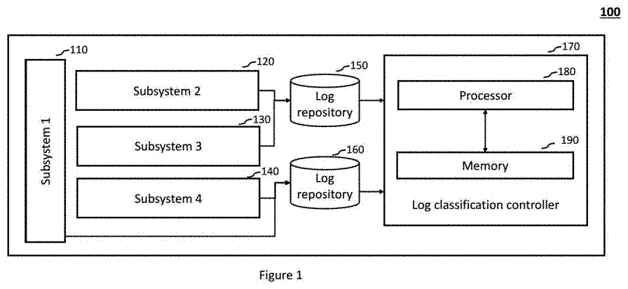

FIG. 1 is a block diagram of an example system 100 with one or more subsystems (110, 120, 130 and 140) and a log classification controller 170. The system 100 is a computer system and may be used in enterprise systems comprising servers, storage networks, communication networks, etc. In an example, the one or more subsystems such as a volume manager subsystem, a kernel subsystem, BIOS subsystem, log repositories (150 and 160), etc., are be present in the system 100.

As generally described herein, a subsystem refers to one or more software or hardware modules or a combination thereof, within the system 100. Each subsystem may include one or more resources such as processing resources (e.g., central processing units, graphics processing units, microcontrollers, application-specific integrated circuits, programmable gate arrays, and/or other processing resources), storage resources (e.g., random access memory, non-volatile memory, solid state drives, hard disk drives HDDs, optical storage devices, tape drives, and/or other suitable storage resources), network resources (e.g., Ethernet, IEEE 802.11 Wi-Fi, and/or other suitable wired or wireless network resources), I/O resources, and/or other suitable resources. Each subsystem may have metadata associated with it, which may be in the form of labels or annotations specifying different attributes (e.g., configuration attributes) related to the subsystem. Each subsystem may be connected to other subsystems in the system 100 and is capable transferring data to other subsystems in the system 100. In an example, one or more subsystems are deployed a dedicated on premise infrastructure. Similarly, in another example one or more subsystems are deployed on a remote infrastructure.

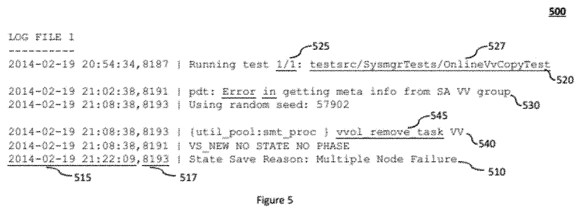

Each subsystem performs a plurality of operations and stores metadata regarding the operations in one or more log files (also known as process log files). The log files are stored in one or more log repositories 150 and 160, Each log file contains a plurality of log lines. Each log line is indicative of an event or operation related to the corresponding subsystem. Each log line includes a timestamp and a process identifier to indicate the time at which the event occurred or the operation was carried out and the computing process in relation to which the event or operation is related. For example, as illustrated in FIG. 5, log line 510 includes timestamp 515 and process identifier 517.

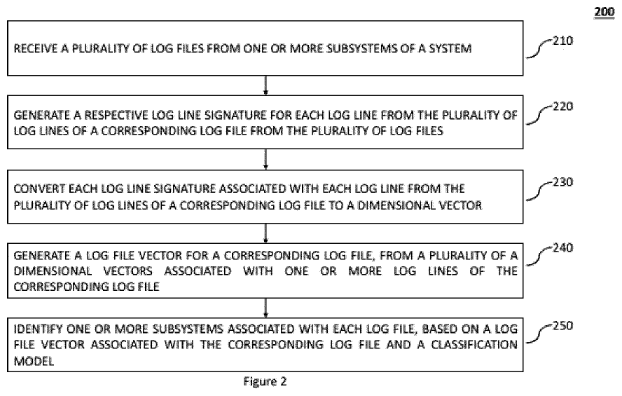

Upon the occurrence of a fault or anomaly states in the system 100, logs files are analyzed to identify potential root causes and to rectify the condition of the system 100. In this regard, the system 100 includes a log classification controller 170. The log classification controller 170 comprises at least one processor 180 and non-transitory storage medium 190. The log classification controller 170 receives the log files from the subsystems (e.g. log repositories 150 and 160), and classifies the log files in accordance with the one or more subsystems. Accordingly, during log analysis for fault or anomaly determination, log files classified against a subsystem are analyzed together. In an example, the log files classified against a subsystem may be sent to one or more teams responsible for the subsystem for analysis and root cause determination. This is explained further in the description of FIG. 2.

FIG. 2 illustrates a method 200 for classifying log files in accordance with the one or more subsystems (110, 120, 130 and 140) of the system 100. While, execution of method 200 is described below with reference to log classification controller 170 of the system 100 (as shown in FIG. 1), other computing devices suitable for the execution of method 200 may be utilized. Additionally, implementation of method 200 is not limited to such examples. Although the flowchart as illustrated in FIG. 2 shows a specific order of performance of certain functionalities, method 200 is not limited to that order. For example, the functionalities shown in succession in the flowchart may be performed in a different order, may be executed concurrently or with partial concurrence, or a combination thereof.

At step 210, the log classification controller 170 receives a plurality of log files from one or more subsystems of the system 100. In an example, the log classification controller 115 receives the log files from the one or more log repositories 150 and 160. While examples described herein have the log classification controller 170 receiving log files from one or more log repositories 150 and 160, the log classification controller 170 is capable of receiving log files from other subsystems such as volume manager subsystem, BIOS subsystem, etc.

In an example, the log files (also referred to as process log files) are preprocessed by the log classification controller 170. In an example, the log classification controller 170 normalizes the log files based on number of log lines and the log file with the smallest number of log lines. For example, for one or more log files having a multitude of lines (e.g. 1000 log lines), the log files are split into smaller log files (e.g. five log files with 200 log lines) having a number of log lines as the log file with the smallest number of log lines (having 200 log lines).

In another example, the log classification controller 170 determines one or more related log lines across the process log files on the basis of system tokens, timestamps and process identifiers of the log lines in the process log files. Unlike other text documents, log files are generated by subsystems and therefore contains information in relation events and errors pertaining to the corresponding subsystem, for instance keywords belonging to a specific sub-module of the subsystem will co-occur together. Accordingly, using a predetermined bag of tokens containing system states (e.g. MOD_DCOW, VS_CLOSE), return values (e.g. 255, −1, 0xFF) and negativity attributes (e.g. Fail, ERROR, Panic), the log classification controller 170 determines related log lines and use process identifiers to group blocks of log lines together to retain spatial relationship between the log lines. Then, the log classification controller 170 extracts the one or more related log lines and appends the related log lines in a new log file. In an example, the log classification controller 170 groups log lines on the basis of process identifier and sorts the log lines on the basis of timestamps. For example, as shown in FIG. 5, the log file 1 (500) contains negativity attribute ‘Error’ in log line 530 and system token ‘vvol_remove_task’ 545 in the log line 540. On the basis of these, the log classification controller extracts that the related log lines 510-540 and appends these lines in a new log file along with other related log lines from other process logs files.

In an example, the log classification controller 170 removes a plurality of predefined words associated with the system 100 from each log line from each log file from the plurality of log files. In an example, timestamps, process identifiers and system specific stop words are removed. For example, as shown in FIG. 5, the example log file 1 (500) contains noise phase ‘1/1’ 525 in log line 520 and stop word ‘in’ in log line 530. These are removed from log lines 520 and 530 by the log classification controller 170. Additionally, in an example, the log classification controller 170 replaces subsystem specific tokens with common tokens to make log data independent of subsystem specific information. For example, uniform resource locators (URLs) in log files are replaced with constant literal ‘PATH’. For example, as shown in FIG. 5, the example log file 1 includes a URL ‘testsrc/SysmgrTests/OnlineVvCopyTest’ 527 in the logline 520. The log classification controller 170 replaces the above URL 527 with constant literal ‘PATH’.

At step 220, the log classification controller 170 generates a respective log line signature for each log line from the plurality of log lines of a corresponding log file from the plurality of log files. In an example, the log classification controller 170 hashes each log line using a predetermined hash function to generate a corresponding log line signature. In an example, the predetermined hash function is SHA-2 technique. For example, each log line is hashed to a 6 letter code. Line 510 is hashed to generate the code ‘DAHEAE’. Since the log lines are originate from product source code and thus the structure for a particular log line remains the same throughout the system, so unlike general English, there is no interchanging of the word sequences. Accordingly, the hashing of log lines to log line signatures is performed by the log classification controller 170.

At step 230, the log classification controller 170 converts each log line signature associated with each log line from the plurality of log lines of a corresponding log file to a dimensional vector. In an example, the log classification controller 170 generates a string using a predetermined number of log line signatures. Then the string is processed using a language modelling technique to generate the dimensional vector. In an example, the language modelling technique is a word embedding technique. For example, the log classification controller 170 generates the string by appending 20 log line signatures associated with 20 sequential log lines. The word embedding technique is applied by the log classification controller 170 to generate a multi-dimensional vector for a corresponding log line signature in the corresponding log file. The multi-dimensional vectors associated the plurality of log lines are indicative of contextual and spatial relation between the log lines in the log file.

Examples of word embedding techniques includes fastText, Word2Vec, etc. In an example, the word embedding technique is performed using fasfText library. FastText library is a library by Facebook AI Research (FAIR) for efficient learning of word representations by generating n-grams from the words to evaluate textual similarity. Using the fastText library, the log classification controller 170 converts each log line signature into a multi-dimensional vector, such that the contextual and spatial relationship between the log line signatures (i.e. the log lines) are retained. In an example, each log line signature is converted to a 100 dimensional vector. Finally, considering a vector dimension of 100, running for 1000 epochs with learning rate 0.01 and context-window of 7 log line signatures, the log classification controller 170 generates the vectors for each log line signature.

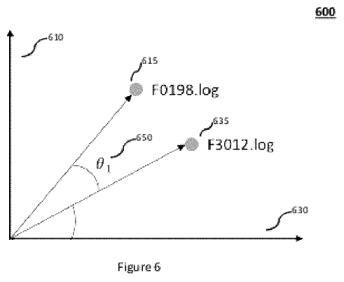

For example, as shown in FIG. 6, in vector space, angle θ₁ 650 between a first dimensional vector F0198.log 615 and a second dimensional vector F3012.log 635 from the plurality of dimensional vectors is indicative of a relationship between a first log line associated with the first dimensional vector 615 and a second log line associated with the second dimensional vector 635. The relationship between a first log line associated with the first dimensional vector 615 and a second log line associated with the second dimensional vector 635 is of a contextual and textual similarity between the first log line and the second log line.

In an example, the relationship between the first log line and the second line is calculated based on the cosine function of the angle θ₁ 650 between the corresponding first dimensional vector 615 and second dimensional vector 635. In an example, the relationship between the first log line and the second line is determined based on the cosine similarity of the first dimensional vector 615 and the second dimensional vector 635 and the angle θ₁ 650 between the corresponding first dimensional vector 615 and second dimensional vector 635.

At step 240, the log classification controller 170 generates a log file vector for a corresponding log file, from a plurality of a dimensional vectors associated with one or more log lines of the corresponding log file. In an example, the log classification controller 170 generates the log file vector for a corresponding log file, from a plurality of a dimensional vectors by calculating a mean vector from the plurality of dimensional vectors.

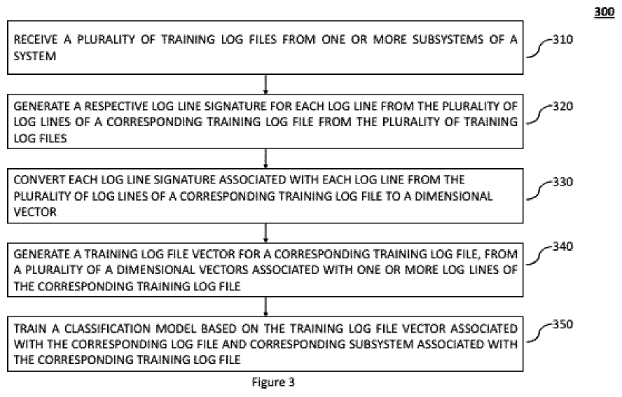

At step 250, the log classification controller 170 identifies one or more subsystems associated with each log file, based on a log file vector associated with the corresponding log file and a classification model. For example, the classification model is a neural network classifier model trained using plurality of training log data. Training of the classification model is further explained in the description of FIG. 3.

FIG. 3 illustrates a method 300 for training a classification model for classifying log files in accordance with the one or more subsystems (110, 120, 130 and 140) of the system 100. While, execution of method 300 is described below with reference to log classification controller 170 of the system 100 (as shown in FIG. 1), other computing devices suitable for the execution of method 300 may be utilized. Additionally, implementation of method 300 is not limited to such examples. Although the flowchart as illustrated in FIG. 3 shows a specific order of performance of certain functionalities, method 300 is not limited to that order. For example, the functionalities shown in succession in the flowchart may be performed in a different order, may be executed concurrently or with partial concurrence, or a combination thereof. Additionally, while method 300 is illustrated and described separately, the method 300 may be implemented as a part of method 200. In an example, the steps of training of the classification model as described in method 300, may be performed prior to utilizing the classification model as mentioned in method 200.

At step 310, the log classification controller 179 receives a plurality of training log files from one or more subsystems of the system 100. Each training log file is associated with historic operations of a subsystem from one or more subsystems of the system 100. In an example, the log classification controller 170 receives the training log files from the one or more log repositories 150 and 160.

In an example, the training log files (also referred to as process training log files) are preprocessed by the log classification controller 170, as described above. The log classification controller 170 determines one or more related log lines across the process training log files on the basis of system tokens, timestamps and process identifiers of the log lines in the process log files. In an example, the log classification controller 170 removes a plurality of predefined words associated with the system from each log line from each training log file from the plurality of training log files. In an example, timestamps, process identifiers and system specific stop words are removed. Additionally, in an example, the log classification controller 170 replaces subsystem specific tokens with common tokens to make log data independent of subsystem specific information. For example, uniform resource locators (URLs) in training log files are replaced with constant literal “PATH”.

At step 320, the log classification controller 170 generates a respective log line signature for each log line from the plurality of log lines of a corresponding training log file from the plurality of log files. In an example, the log classification controller 170 hashes each log line using a predetermined hash function to generate a corresponding log line signature. In an example, the predetermined hash function is SHA-2 technique as known in the state of the art. In an example, the number of characters for the log line signature is determined by the log classification controller 170 based on the number of unique log lines after preprocessing the log lines as described above. For example, each log line is hashed to a 6 letter code. For Line 510 of example log file 1 in FIG. 5, is hashed to generate the code ‘DAHEAE’.

At step 330, the log classification controller 170 converts each log line signature associated with each log line from the plurality of log lines of a corresponding training log file to a dimensional vector. In an example, the log classification controller 170 generates a string using a predetermined number of log line signatures. Then the string is processed using language modelling technique (as known in the state of art) to generate the dimensional vector. In an example, the language modelling technique is a word embedding technique. For example, the log classification controller generates the string by appending 20 log line signatures associated with 20 sequential log lines. The word embedding technique is applied by the log classification controller 170 to generate a multi-dimensional vector for the corresponding log line signature. The multi-dimensional vectors associated with the plurality of log lines are indicative of contextual and spatial relation between the log lines. In vector space, angle between a first dimensional vector from the plurality of dimensional vectors and a second dimensional vector from the plurality of dimensional vectors is indicative of a relationship between a first log line associated with the first dimensional vector and a second log line associated with the second dimensional vector. The relationship between a first log line associated with the first dimensional vector and a second log line associated with the second dimensional vector is of a contextual and textual similarity between the first log line and the second log line.

At step 340, the log classification controller 170 generates a training log file vector for a corresponding training log file, from a plurality of a dimensional vectors associated with one or more log lines of the corresponding training log file. In an example, the log classification controller 170 generates the training log file vector for a corresponding training log file, from a plurality of a dimensional vectors by calculating a mean vector from the plurality of dimensional vectors.

At step 350, the log classification controller 170 trains the classification model by feeding the training log vector of the corresponding training log file and associated subsystem names to the classification model. This is iteratively carried out to continuously train the model. For example, if the accuracy of the classification of the log classification controller 170 is below a predetermined threshold, the model is retrained using log files from a predetermined time window, for example, from the last six months. Model retraining may be involved when a new subsystem is added or when the firmware of the one or more subsystems is updated.

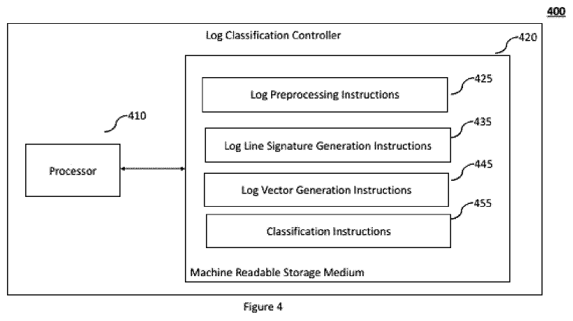

FIG. 4 is a block diagram 400 of the log classification controller 170. The log classification controller 170 comprises at least one processor 410 and machine-readable non transitory storage medium 420, communicatively coupled to a processor 410. The controller 170 (machine-readable medium 420 and processor 410) may, for example, be included as part of computing system 100 illustrated in FIG. 1.

Although the following descriptions refer to a single processor 410 and a single machine-readable storage medium 420, the descriptions may also apply to a controller with multiple processors and/or multiple machine-readable storage mediums. In such examples, the instructions may be distributed (e.g., stored) across multiple machine-readable storage mediums and the instructions may be distributed (e.g., executed by) across multiple processors.

Processor 410 may be central processing units (CPUs), microprocessors, and/or other hardware devices suitable for retrieval and execution of instructions stored in machine-readable storage medium 420, In the example shown in FIG. 4, processor 410 may fetch, decode, and execute machine-readable instructions 420 (including instructions 425-455) for classifying log files. As an alternative or in addition to retrieving and executing instructions, processor 410 may include electronic circuits comprising a number of electronic components for performing the functionality of the instructions in machine-readable storage medium 300. With respect to the executable instruction representations (e.g., boxes) described and shown herein, it should be understood that part or all of the executable instructions and/or electronic circuits included within one box may, in some examples, be included in a different box shown in the figures or in a different box not shown.

Machine-readable storage medium 420 may be any electronic, magnetic, optical, or other physical storage device that stores executable instructions. Thus, machine-readable storage medium 420 may be, for example, Random Access Memory (RAM), a nonvolatile RAM (NVRAM) (e.g., RRAM, PCRAM, MRAM, etc.), an Electrically-Erasable Programmable Read-Only Memory (EEPROM), a flash memory, a storage drive, an optical disc, and the like. Alternatively, machine-readable storage medium 420 may be a portable, external or remote storage medium, for example, that allows a computing system to download the instructions from the portable/external/remote storage medium. In this situation, the executable instructions may be part of an “installation package”. As described herein, machine-readable storage medium 420 may be encoded with executable instructions for classifying log files.

Referring to FIG. 4, log preprocessing instructions 425, when executed by processor 410, may cause the processor to preprocess the log files as described above. Log line signature generation instructions 435, when executed by the processor 410, may cause the processor to generate log line signature for log lines of the plurality of log files as described above. Log vector generation instructions 445, when executed by the one or more processors 410, causes the processors to generate multi-dimensional vectors for the log line signatures and then generate log vector from the multi-dimensional vectors. Classification instructions 455, when executed by the one or more processors, causes the processors to classify a corresponding log file on the basis of the corresponding log vector and the classification model.

In an example, the non-transitory storage medium contains additional instructions which when executed by the at least one processor causes the processor to remove of a plurality of predefined words associated with the system from each log line from each log file from the plurality of log files.

In an example, the non-transitory storage medium contains additional instructions which when executed by the at least one processor causes the processor receive a plurality of training log files of a system, each training log file is associated with historic operations of a subsystem from one or more subsystems of the system; generate a respective log line signature for each log line from the plurality of log lines of a corresponding training log file from the plurality of training log files; convert each log line signature from a plurality of log line signatures associated with each log line from the plurality of log lines of a corresponding training log file to a dimensional vector; generate a training log file vector for a corresponding training log file, from a plurality of a dimensional vectors associated with one or more log lines of the corresponding training log file, and train a classification model based on the training log file vector associated with the corresponding log file and corresponding subsystem associated with the corresponding training log file.

FIG. 5 illustrates section 500 of an example log file 1. The log file 1 comprises a plurality of log lines (log lines 510-540). As shown in the figure, each log line contains a time stamp and process identifier. For example, log line 510 contains timestamp 515 and process identifier 517.

FIG. 6 illustrates a first dimensional vector F0198.log (615) and second dimensional vector F3012.log (635) in a representative vector space. The axes 610 and 630 are illustrative axes generated on basis of principal component analysis. There is an angle θ₁ 650 between the first dimensional vector 615 and second dimensional vector 635. A cosine function of the angle θ₁ (650) is indicative of similarity between first log line associated with first dimensional vector 615 and second log line associated with second dimensional vector 635.

The foregoing disclosure describes a number of example implementations for classification of log files. The disclosed examples may include systems, devices, computer-readable storage media, and methods for classification of log files. For purposes of explanation, certain examples are described with reference to the components illustrated in FIGS. 1-6. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments such as banking systems, industrial control systems, telephony systems, transportation and automobile systems, etc. and are not limited to the illustrated examples. Further, the sequence of operations described in connection with FIGS. 2 and 3 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method comprising:
receiving a plurality of log files from one or more subsystems of a system, wherein each log file includes a plurality of log lines associated with one or more events in the system, each line from the plurality of log lines comprising at least one of a timestamp and a process identifier;
generating a respective log line signature for each log line from the plurality of log lines of a corresponding log file from the plurality of log files;
converting each log line signature associated with each log line from the plurality of log lines of a corresponding log file to a dimensional vector;
generating a log file vector for a corresponding log file, based on a plurality of a dimensional vectors associated with the plurality of log lines of the corresponding log file, wherein an angle between a first dimensional vector from the plurality of dimensional vectors and a second dimensional vector from the plurality of dimensional vectors is indicative of a relationship between a first log line associated with the first dimensional vector and a second log line associated with the second dimensional vector; and
identifying one or more subsystems associated with each log file, based on the log file vector associated with the corresponding log file and a classification model.

2. The method as claimed in claim 1, wherein each log file from the plurality of log files is generated by extracting one or more log lines of each process log file from a plurality of process log files based on one or more of one or more corresponding systems tokens, timestamp and process identifier of each log line in the process log files.

3. The method as claimed in claim 1, wherein generating a respective log line signature for each log line from the plurality of log lines of a corresponding log file comprises hashing each log line using a predetermined hash function.

4. The method as claimed in claim 1, wherein the relationship between a first log line associated with the first dimensional vector and a second log line associated with the second dimensional vector, indicative of one of a contextual similarity and a textual similarity between the first log line and the second log line.

5. The method as claimed in claim 1, wherein the method further comprises removing of a plurality of predefined words associated with the system from each log line from each log file from the plurality of log files.

6. The method as claimed in claim 1, wherein generating a log file vector for a corresponding log file, from a plurality of a dimensional vectors comprises calculating a mean vector from the plurality of dimensional vectors.

7. The method as claimed in claim 1, wherein the system is a storage system, wherein one or more of the subsystems of the storage system are deployed in a remote site.

8. The method as claimed in claim 1; further comprising:
receiving a plurality of training log files of a system, wherein each training log file is associated with historic operations of a subsystem from one or more subsystems of the system;
generating a respective log line signature for each log line from the plurality of log lines of a corresponding training log file from the plurality of training log files;
converting each log line signature from a plurality of log line signatures associated with each log line from the plurality of log lines of a corresponding training log file to a dimensional vector;
generating a training log file vector for a corresponding training log file; based on a plurality of a dimensional vectors associated with the plurality of log lines of the corresponding training log file, wherein an angle between a first dimensional vector from the plurality of dimensional vectors and a second dimensional vector from the plurality of dimensional vectors is indicative of a relationship between first log line associated with the first dimensional vector and a second log line associated with the second dimensional vector; and
training a classification model based on the training log file vector associated with the corresponding log file and corresponding subsystem associated with the corresponding training log file.

9. A non-transitory machine-readable storage medium comprising instructions executable by at least one processor of a log classification controller to:
receive a plurality of log files from one or more subsystems of a system; wherein each log file includes a plurality of log lines associated with one or more events in the system, each line from the plurality of lines comprising at least one of a timestamp and a process identifier;
generate a respective log line signature for each log line from the plurality of log lines of a corresponding log file from the plurality of log files;
convert each log line signature associated with each log line from the plurality of log lines of a corresponding log file to a dimensional vector;
generate a log file vector for a corresponding log file, from a plurality of a dimensional vectors associated with one or more log lines of the corresponding log file, wherein an angle between a first dimensional vector from the plurality of dimensional vectors and a second dimensional vector from the plurality of dimensional vectors is indicative of a relationship between a first log line associated with the first dimensional vector and a second log line associated with the second dimensional vector; and
identify one or more subsystems associated with each log file, based on a log file vector associated with the corresponding log file and a classification model.

10. The non-transitory storage medium as claimed in claim 9, wherein the non-transitory storage medium further comprises instructions executable by the at least one processor to remove of a plurality of predefined words associated with the system from each log line from each log file from the plurality of log files.

11. The non-transitory machine-readable storage medium as claimed in claim 9, wherein each log file from the plurality of log files is generated by extracting one or more log lines of each process log file from a plurality of process log files based on one or more of one or more corresponding systems tokens, timestatnp and process identifier of each log line in the process log files.

12. The non-transitory machine-readable storage medium as claimed in claim 9, wherein the relationship between a first log line associated with the first dimensional vector and a second log line associated with the second dimensional vector, indicative of a contextual and textual similarity between the first log line and the second log line.

13. The non-transitory machine-readable storage medium as claimed in claim 9, wherein a respective log line signature for each log line from the plurality of log lines of a corresponding log file, is generated by hashing each log line using a predetermined hash function.

14. The non-transitory machine-readable storage medium as claimed in claim 9, wherein a log file vector for a corresponding log file is generated from a plurality of a dimensional vectors by calculating a mean vector from the plurality of dimensional vectors.

15. The non-transitory storage medium as claimed in claim 9, wherein the non-transitory storage medium further comprises instructions executable by the at least one processor to:
receive a plurality of training log files of a system, wherein each training log file is associated with historic operations of a subsystem from one or more subsystems of the system;
generate a respective log line signature for each log line from the plurality of log lines of a corresponding training log file from the plurality of training log files;
convert each log line signature from a plurality of log line signatures associated with each log line from the plurality of log lines of a corresponding training log file to a dimensional vector;
generate a training log file vector for a corresponding training log file, from a plurality of a dimensional vectors associated with one or more log lines of the corresponding training log file, wherein an angle between a first dimensional vector from the plurality of dimensional vectors and a second dimensional vector from the plurality of dimensional vectors is indicative of a relationship between first log line associated with the first dimensional vector and a second log line associated with the second dimensional vector; and
train a classification model based on the training log file vector associated with the corresponding log file and corresponding subsystem associated with the corresponding training log file.

16. A storage system, comprising:
a plurality of subsystems, each subsystem associated with one or more operations of the storage system;
a plurality of log repositories comprising a plurality of logs; the plurality of log repositories connected to the plurality of subsystems, wherein each log repository containing one or more logs associated with at least one subsystem from the plurality of subsystems and wherein each log file includes a plurality of log lines associated with one or more events in the system, each log line from the plurality of log lines comprising at least one of a timestamp and a process identifier;
a log classification controller comprising at least one processor and at least one non-transitory machine-readable storage medium comprising instructions executable by the at least one processor to:
receive the plurality of log files,
generate a respective log line signature for each log line from the plurality of log lines of a corresponding log file from the plurality of log files;
convert each log line signature associated with each log line from the plurality of log lines of a corresponding log file to a dimensional vector;
generate a log file vector for a corresponding log file, from a plurality of a dimensional vectors associated with one or more log lines of the corresponding log file, wherein an angle between a first dimensional vector from the plurality of dimensional vectors and a second dimensional vector from the plurality of dimensional vectors is indicative of a relationship between a first log line associated with the first dimensional vector and a second log line associated with the second dimensional vector; and
identify one or more subsystems associated with each log file, based on a log file vector associated with the corresponding log file and a classification model.

17. The storage system as claimed in claim 16, wherein the non-transitory storage medium further comprises instructions executable by the at least one processor to remove of a plurality of predefined words associated with the system from each log line from each log file from the plurality of log files.

18. The storage system as claimed in claim 16, wherein each log file from the plurality of log files is generated by extracting one or more log lines of each process log file from a plurality of process log files based on one or more of one or more corresponding systems tokens, timestamp and process identifier of each log line in the process log files.

19. The storage system as claimed in claim 16, wherein a respective log line signature for each log line from the plurality of log lines of a corresponding log file is generated by hashing each log line using a predetermined hash function.

20. The storage system as claimed in claim 16, a log file vector for a corresponding log file is generated from a plurality of a dimensional vectors by calculating a mean vector from the plurality of dimensional vectors.
